(19) United States
(12) Patent Application Publication
(10) Pub. No.: US 2015/0305464 A1
(43) Pub. Date: Oct. 29, 2015

(54) HANDHELD ELECTRONIC DEVICE PROTECTIVE CASE FOR HOLDING AN E-VAPING ARTICLE

(71) Applicants: John R. NELSON, JR., Richmond, VA (US); William J. BOGDZIEWICZ, III, Richmond, VA (US); Scott A. FATH, Richmond, VA (US); Robert T. MITTEN, Glen Allen, VA (US)

(72) Inventors: John R. NELSON, JR., Richmond, VA (US); William J. BOGDZIEWICZ, III, Richmond, VA (US); Scott A. FATH, Richmond, VA (US); Robert T. MITTEN, Glen Allen, VA (US)

(21) Appl. No.: 14/695,317

(22) Filed: Apr. 24, 2015

Related U.S. Application Data
(60) Provisional application No. 61/984,524, filed on Apr. 25, 2014.

(51) Int. Cl. A45C 13/02; H02J 7/02; H02J 7/00; A45C 11/00; A24F 47/00

(52) U.S. Cl. CPC A45C 13/02; A45C 11/00; A24F 47/008; H02J 7/0045; H02J 7/025; A45C 2011/002

(57) ABSTRACT

A handheld electronic device protective case includes a shell with a retention structure attached to the shell. The retention structure is capable or retaining an e-vaping article, where the e-vaping article is a blister pack or an e-vaping item. The retention structure can be a storage portion with a holding member that slideably receives and retains a blister pack, and a locking member that impedes the blister pack from sliding from the storage portion. The retention structure can also include a cavity or a compartment that receives and retains a cylindrically-shaped e-vaping item.

### PRIORITY STATEMENT

This application is a non-provisional application that claims priority to U.S. provisional app. No. 61/984,524, filed on Apr. 25, 2014, the entire contents of which is incorporated by reference in its entirety.

### BACKGROUND OF THE INVENTION

1. Field of the Invention

Example embodiments relate generally to a protective case for a handheld electronic device. The protective case may hold an electronic vaping (“e-vaping”) article.

2. Related Art

E-vaping devices may be used by adult vapers as a potentially portable means of vaping. While the portability of an e-vaping device may be a convenience, the e-vaping device often requires replacement of a cartridge that contains a vapor precursor, especially following an extended use of the e-vaping device. Likewise, a power supply of the e-vaping device also may require a recharge, or the power supply may need to be replaced, as the e-vaping device is used over a period of time.

Handheld electronic devices, such as mobile phones, tablets, and e-Readers, etc., may also be used as a conveniently portable means of providing an adult vaper with entertainment while allowing a user to stay digitally connected with work, friends, social networking, etc. While the portability of these handheld electronic devices may also be a convenience, the handheld electronic devices also require a recharged power supply, especially over an extended period of use.

### SUMMARY OF THE INVENTION

At least one example embodiment relates to a protective case for a handheld electronic device.

In one example embodiment, the protective case includes a shell configured to attach to the handheld electronic device; and a retention structure attached to the shell, the retention structure being configured to retain at least a first e-vaping article, the first e-vaping article being one of a blister pack and a first e-vaping item, the first e-vaping item being substantially cylindrically-shaped.

In one embodiment, the retention structure is a storage portion configured to retain the blister pack, the retention structure including, a holding member configured to slideably receive and retain at least one edge of a blister pack, and a locking member configured to impede the blister pack from sliding out of the storage portion.

In one embodiment, the holding member includes at least one ledge defining a slot, the slot being configured to receive the at least one edge of the blister pack.

In one embodiment, the at least one ledge includes opposing first and second ledges, the first and second ledges having longitudinal lengths that are positioned to be about parallel to each other.

In one embodiment, the at least one ledge includes a stop positioned near an end of the at least one ledge, the stop being positioned to physically stop the blister pack from sliding away from the locking member.

In one embodiment, the locking member includes a lip on a distal end of the locking member, the lip being configured to impede the blister pack from sliding out of the storage portion.

In one embodiment, the lip of the locking member extends away from a surface of the shell while in a resting position, the lip being configured to impede the blister pack from sliding out of the storage portion while in the resting position.

In one embodiment, the locking member is configured to be depressed in order to cause the lip to be about flush with the surface of the shell while in a non-resting position, the lip being configured to allow the blister pack to slide out of the storage portion while in the non-resting position.

In one embodiment, the at least one ledge and the locking member are configured to retain a blister pack that is one of substantially rectangular and oval shaped, wherein the blister pack has a width of about 2 to 3 cm and a length of about 5 to 6 cm.

In one embodiment, the retention structure includes at least a first cavity defined by the shell, the first cavity being configured to slideably receive and retain at least a first portion of the first e-vaping item via a frictional force.

In one embodiment, the protective case further includes a first stop positioned on an outer surface of the shell and located adjacent to the first cavity, the first stop being configured to physically stop the first e-vaping item from sliding out of the first cavity.

In one embodiment, the protective further includes an auxiliary power supply retained in the shell, the auxiliary power supply being configured to electrically charge the first e-vaping item.

In one embodiment, the protective case further includes a charging station connected to the shell, the charging station being configured to electrically connect to the auxiliary power supply to allow the auxiliary power supply to electrically charge a battery of the first e-vaping item.

In one embodiment, the charging station includes a conductive contact that is configured to electrically connect the auxiliary power supply to one of an anode connection and a cathode connection of the first e-vaping item in order to electrically charge the battery of the first e-vaping item.

In one embodiment, the charging station includes a primary induction coil that is configured to produce a current in a secondary induction coil of the first e-vaping item in order to electrically charge the battery of the first e-vaping item.

In one embodiment, the protective case further includes electrical wiring electrically connecting the auxiliary power supply to a power supply of the handheld electronic device in order to allow the auxiliary power supply to electrically charge the power supply of the handheld electronic device.

In one embodiment, the protective case further includes a power switch with a selectable first position and a second position, the first position of the power switch causing the auxiliary power supply to electrically charge the first e-vaping item via the charging station, the second position of the power switch causing the auxiliary power supply to electrically charge the power supply of the handheld electronic device.

In one embodiment, the protective case further includes at least one spring is positioned in the first cavity, the at least one spring being configured to assist in discharging the first e-vaping item if the first e-vaping item is being removed from the first cavity.

In one embodiment, the protective case further includes an antimicrobial agent on an inner surface of at least a portion of the at least one cavity.

In one embodiment, the protective case further includes the shell defining at least a second cavity configured to slideably receive and retain at least a second portion of the e-vaping item via a friction force, the first cavity and the second cavity being about collinear with each other.

In one embodiment, the retention structure includes at least a first compartment defined by the shell, the first compartment being configured to retain the first e-vaping item.

In one embodiment, the protective case further includes a cover attached to the shell and configured with selectable first and second positions, the first position being configured to cause the cover to conceal the first compartment, the second position being configured to allow the first compartment to be accessed.

In one embodiment, the first compartment includes an arcuate-shaped surface configured to mate with the first e-vaping item.

In one embodiment, the cover is a slideable cover including at least one rail that is mateable with at least one recess that is defined by the shell, the at least one recess being positioned adjacent to a longitudinal length of the first compartment.

In one embodiment, the slideable cover is configured to slide between the first position and the second position via the at least one rail sliding within the at least one recess.

In one embodiment, the shell defines at least a second compartment configured to retain at least a second e-vaping item that is substantially cylindrically-shaped, the slideable cover is further configured to allow the second compartment to be accessed if the slideable cover is in the first position, the slideable cover is further configured to conceal the second compartment if the slideable cover is in the second position.

In one embodiment, the first compartment is configured to retain at least a second e-vaping item, the second e-vaping item being substantially cylindrically shaped.

In one embodiment, the slideable cover is further configured to selectably slide to a third position, the slideable cover is further configured to conceal the first and second compartments if the slideable cover is in the third position.

In one embodiment, the protective case further includes an antimicrobial agent on at least a portion of an inner surface of the first compartment.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a cross-sectional view of an e-vaping device, in accordance with an example embodiment;

FIG. 2 is an e-vaping blister pack including replacement cartridges, in accordance with an example embodiment;

FIG. 3 is an illustration of a protective case for a handheld electronic device, in accordance with an example embodiment;

FIG. 4, is another perspective view of the protective case of FIG. 3, in accordance with an example embodiment;

FIG. 5 is another perspective view of the protective case of FIG. 3, in accordance with an example embodiment;

FIG. 6 is another perspective view of the protective case of FIG. 3, in accordance with an example embodiment;

FIG. 7 is illustration of another protective case for a handheld electronic device, in accordance with an example embodiment;

FIG. 8 is illustration of another protective case for a handheld electronic device, in accordance with an example embodiment;

FIG. 9 is an illustration of another protective case for a handheld electronic device, in accordance with an example embodiment;

FIG. 10 is another perspective view of the protective case of FIG. 9, in accordance with an example embodiment;

FIG. 11 is an illustration of the protective case of FIG. 9, with a slideable cover shown in a first position, in accordance with an example embodiment;

FIG. 12 is an illustration of the protective case of FIG. 9, with a slideable cover shown in a second position, in accordance with an example embodiment;

FIG. 13 is an illustration of the protective case of FIG. 9, shown without the slideable cover, in accordance with an example embodiment;

FIG. 14 is an illustration of the slideable cover of FIG. 9, in accordance with an example embodiment;

FIG. 15 is an illustration of another perspective of the slideable cover of FIG. 9, in accordance with an example embodiment;

FIG. 16A is an illustration of an adult vaper attempting to place a blister pack into a storage portion of a protective case, in accordance with an example embodiment;

FIG. 16B is an illustration of the blister pack resting in the storage portion of the protective case of FIG. 16A, in accordance with an example embodiment;

FIG. 16C is an illustration of a distal end of the blister pack contacting a raised lower lip of the protective case of FIG. 16A, in accordance with an example embodiment;

FIG. 16D is an illustration of the blister pack firmly secured in the storage portion of the protective case of FIG. 16A, in accordance with an example embodiment; and

FIG. 17 is an illustration of a blister pack and an e-vaping device being stored in a protective case, in accordance with an example embodiment.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, items, regions, layers and/or sections, these elements, items, regions, layers, and/or sections should not be limited by these terms. These terms are only used to distinguish one element, item, region, layer, or section from another region, layer, or section. Thus, a first element, item, region, layer, or section discussed below could be termed a second element, item, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or items, but do not preclude the presence or addition of one or more other features, integers, steps, operations, elements, items, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

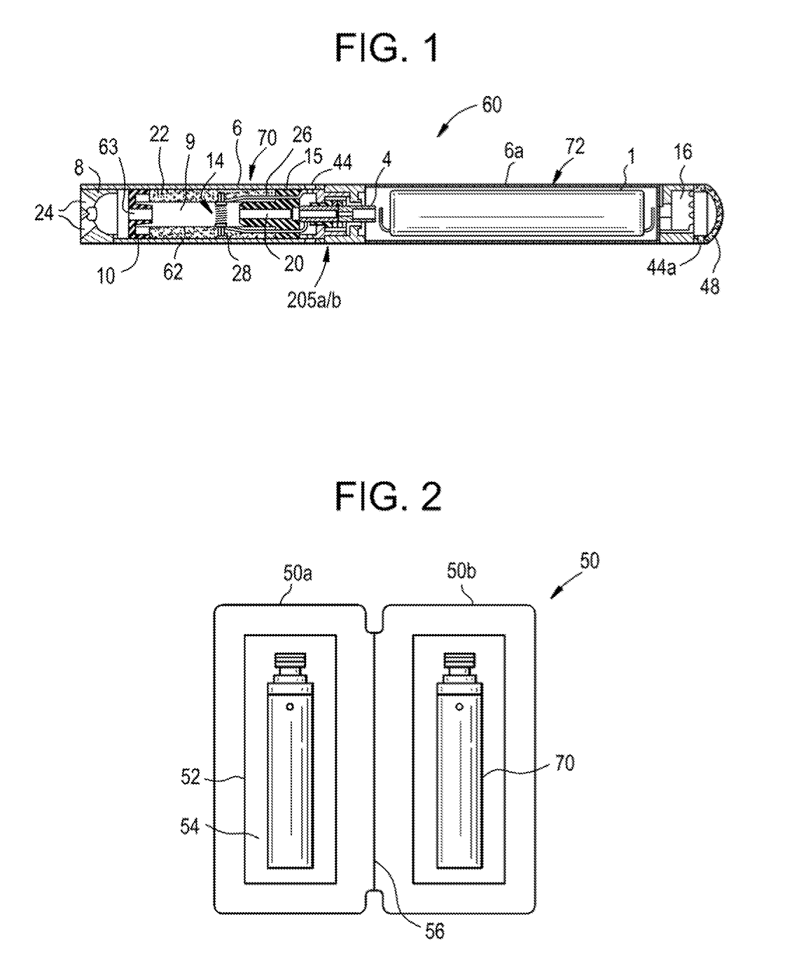

FIG. 1 is a cross-sectional view of an e-vaping article that is an e-vaping device 60, in accordance with an example embodiment. The e-vaping device 60 may include major e-vaping items, including a cartridge (or first section, which may be a “cartomizer”) 70 and a reusable section (or second section) 72. The cartridge 70 and the reusable section 72 may be coupled together at a threaded connection 205a/b (where 205a may be a male threaded connection on cartridge 70, and 205b may be a female threaded connection on reusable fixture 72), or coupled together by other convenience such as a snug-fit, detent, clamp and/or clasp. The first section 70 may be a disposable section, or alternatively a reusable section. The first section 70 may include an outer tube 6 (or housing) extending in a longitudinal direction and an inner tube 62 coaxially positioned within the outer tube or housing 6. The second section 72 may be a reusable section, or alternatively, this section may also be disposable section (although portions of this document may refer to this section as a “reusable” section, for simplicity sake). The second section 72 may include an outer tube 6a (or housing) extending in a longitudinal direction. In an alternative embodiment, the outer tube 6/6a may be a single tube housing both the first section 70 and the second section 72 and the entire e-vaping device 60 may be disposable.

In an embodiment, the e-vaping device 60 may also include a central air passage 20 defined in part by inner tube 62 and an upstream seal 15. Moreover, the e-vaping device 60 may include a vapor precursor supply reservoir 22. The supply reservoir may contain a vapor precursor. The vapor precursor may be a material or combination of materials that may be transformed into a vapor. For example, the vapor precursor may be a liquid, solid and/or gel formulation including, but not limited to, water, beads, solvents, active ingredients, ethanol, plant extracts, natural or artificial flavors, and/or vapor formers such as glycerine and propylene glycol. In an embodiment, the supply reservoir 22 may be contained in an outer annulus between the outer tube 6 and the inner tube 62. The annulus may be sealed at an upstream end by the seal 15 and by a stopper 10 at a downstream end so as to prevent leakage of the vapor precursor from the supply reservoir 22. The vapor precursor in the supply reservoir 22 may include a tobacco-containing material including volatile tobacco flavor compounds which are transformed into vapor upon heating. The vapor precursor may also be a tobacco flavor containing material or a nicotine-containing material. Alternatively, or in addition, the vapor precursor may include a non-tobacco material.

In an embodiment, a heater 14 may be contained in the inner tube 62 downstream of and in spaced apart relation to the portion of central air passage 20 defined by the seal 15. The heater 14 may be in the form of a wire coil, a planar body, a ceramic body, a single wire, a cage of resistive wire or any other suitable form. A wick 28 may be in communication with the vapor precursor in the supply reservoir 22 and in communication with the heater 14 such that the wick 28 disposes vapor precursor in proximate relation to the heater 14. The wick 28 may be constructed of a fibrous and flexible material. The wick 28 may include at least one filament having a capacity to draw a vapor precursor. For example, the wick 28 may comprise a bundle of filaments which may include glass (or ceramic) filaments. In another embodiment, a bundle comprising a group of windings of glass filaments, for example, three of such windings, all which arrangements are capable of drawing a vapor precursor via capillary action via interstitial spacing between the filaments. A power supply 1 in the second section 72 may be operably connected to the heater 14 (as described below) to apply voltage across the heater 14. The e-vaping device 60 also may include at least one air inlet 44 operable to deliver air to the central air passage 20 and/or other portions of the inner tube 62.

In an embodiment, the e-vaping device 60 may further include a mouth end insert 8 having at least two off-axis, diverging outlets 24. The mouth end insert 8 may be in fluid communication with the central air passage 20 via the interior of inner tube 62 and a central passage 63, which extends through the stopper 10. The heater 14 may extend in a direction transverse to longitudinal length of outer air passage in order to heat the vapor precursor to a temperature sufficient to vaporize the vapor precursor and form a vapor. The heater 14 may be arranged centrally within the inner tube 62. However, in other embodiments, the heater 14 may be arranged adjacent an inner surface of the inner tube 62.

In an embodiment, the first section (the cartridge) 70 may be disposable and the second section (the fixture) 72 may be reusable. The sections 70, 72 can be attached by a threaded connection 205, as described above, whereby the downstream section 70 may be replaced when the supply reservoir 22 is depleted. Having a separate first section 70 and second section 72 provides a number of advantages. First, if the first section 70 contains the at least one heater 14, the supply reservoir 22 and the wick 14, all elements which are potentially in contact with the vapor precursor are disposed of when the first section 70 is replaced. Thus, there will be no cross-contamination between different mouth end inserts 8, for example, when using different vapor precursor materials. Also, if the first section 70 is replaced at suitable intervals, there is little chance of the heater becoming clogged with vapor precursor. Optionally, the first section 70 and the second section 72 may be arranged to releaseably lock together when engaged.

In an embodiment, the power supply 1 may include a battery arranged in the second section 72 (i.e., the upstream end of the e-vaping device 60) such that the anode is downstream of the cathode. A battery anode connector 4 may contact the downstream end of the battery. The heater 14 may be connected to the battery by two spaced apart electrical leads 26. An air inlet 44a may be positioned in the second section 72 adjacent a puff sensor 16. Puff sensor 16 may supply power to the heater 14 via the electrical leads 26 upon sensing a puff by an adult vaper on mouth end insert 8. Air inlet 44a may fluidly communicate with the mouth end insert 8 so that a draw upon the mouth end insert activates the puff sensor 16. The air from the air inlet 44a may then flow along the power supply 1 and into central air passage 20 in the seal 15 and/or to other portions of the inner tube 62 and/or outer tube 6. The additional air inlet 44, located in first section 70, can also assist in generate air flow that is drawn into the central air passage. The puff sensor may also activate a light 48 on a distal end of the second section 72 in order to indicate that the e-vaping device 60 is in use.

FIG. 2 illustrates an e-vaping article that is a blister pack 50, in accordance with an example embodiment. The blister pack 50 may include one or more replacement cartridges 70. The blister pack 50 may come in separate, identical sections 50a/b, which may be held together via a perforated seam 56. Each section 50a/b may include a thermoplastic covering that may form a hermetically sealed pouch 52 containing a disposable cartridge 70.

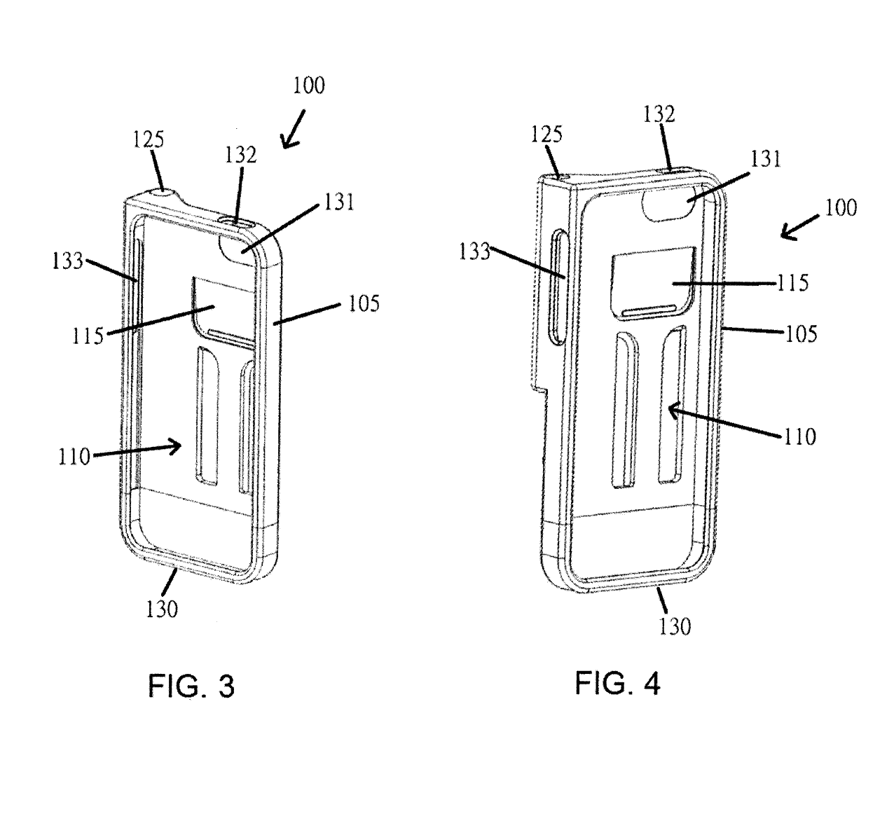

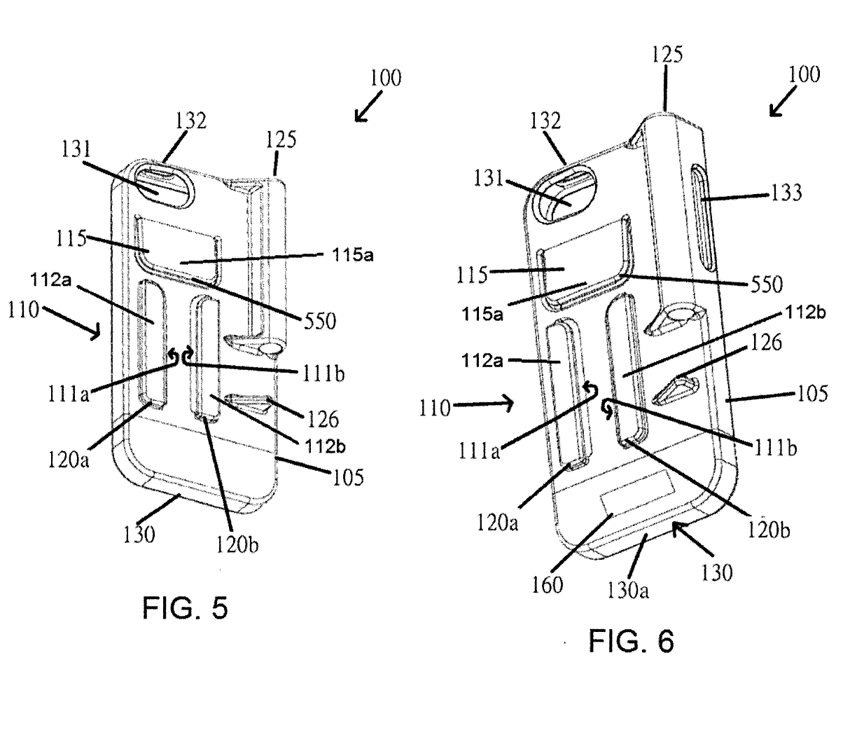

FIGS. 3 and 4 illustrate front-side perspective views of a protective case 100 for a handheld electronic device, in accordance with an example embodiment. The protective case 100 may be sized to protect handheld electronic devices that may include a mobile phone, a tablet, an electronic reader (“e-reader”), or other portable electronic device. The protective case 100 may include a shell 105 that may be formed from molded, somewhat malleable plastic that may be fashioned to envelope one or more sides of a handheld electronic device. The shell 105 may include a retention structure that may be a storage portion 110 (shown in better detail in FIGS. 5 and 6) that may include a locking member 115 and at least one ledge (holding member) 112a/b (see FIGS. 5 and 6), such that the storage portion 110 may store a spare cartridge 70 that may include a vapor precursor supply. The spare cartridge 70 may be stored while disposed in a blister pack 50. For instance, the storage portion 110 may store one individual blister pack 50a of a pair of blister packs 50 (as shown in FIG. 2). Or, alternatively, the storage portion 110 may be configured to store an entire pair of blister packs 50 (i.e., both blister pack 50a and blister pack 50b). While the remainder of this document primarily refers to the storage of a single blister pack 50a, both embodiments are equally envisioned.

As shown in FIGS. 5 and 6 (showing a back-side perspective of the protective case 100 of FIGS. 3 and 4), the holding member of the storage portion 110 may include two opposed, substantially parallel ledges 112a/b which may form respective slots 111a/b capable of slideably receiving and retaining an edge of a blister pack 50a, when the blister pack 50a is inserted therein. The storage portion 110 may also include a resilient locking member 115 which may secure a blister pack 50a within the storage portion 110 once the blister pack 50a is inserted between the ledges 112a/b.

The ledges 112a/b and the resilient locking member 115 may be arranged such that this structure may hold a blister pack 50a which has a substantially rectangular or oval shaped base having a width of about 2 to 3 cm and a length of about 5 to 6 cm. Each of opposed ledges 112a/b may also include a respective stop 120a/b at a distal end of each ledge 112a/b. The stops 120a/b may catch a lower (distal) edge of the blister pack 50a when the blister pack 50a is fully inserted into the slots 111a/b of the storage portion 110. Alternatively, a single stop may also be in the shell 105 of the protective case 100 such that the two opposed ledges 112a/b terminate at the ledge. Alternatively, a projection may also be used rather than the two opposed ledges 112a/b, where a blister pack 50a may be held in place by a snap fit among the projection and the resilient locking member 115.

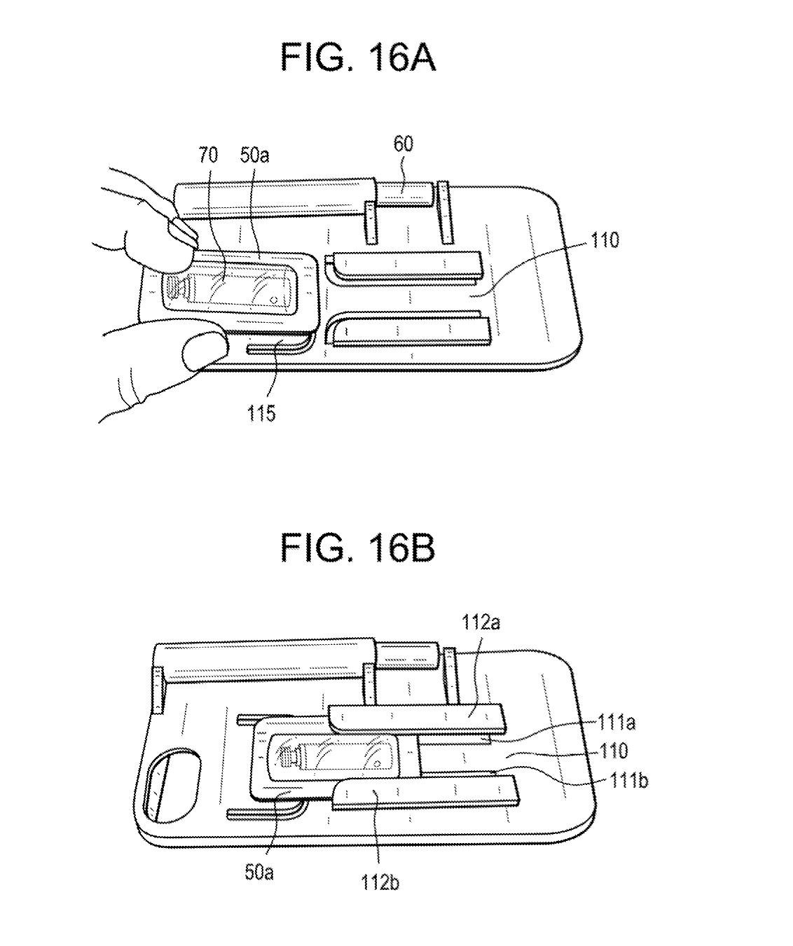

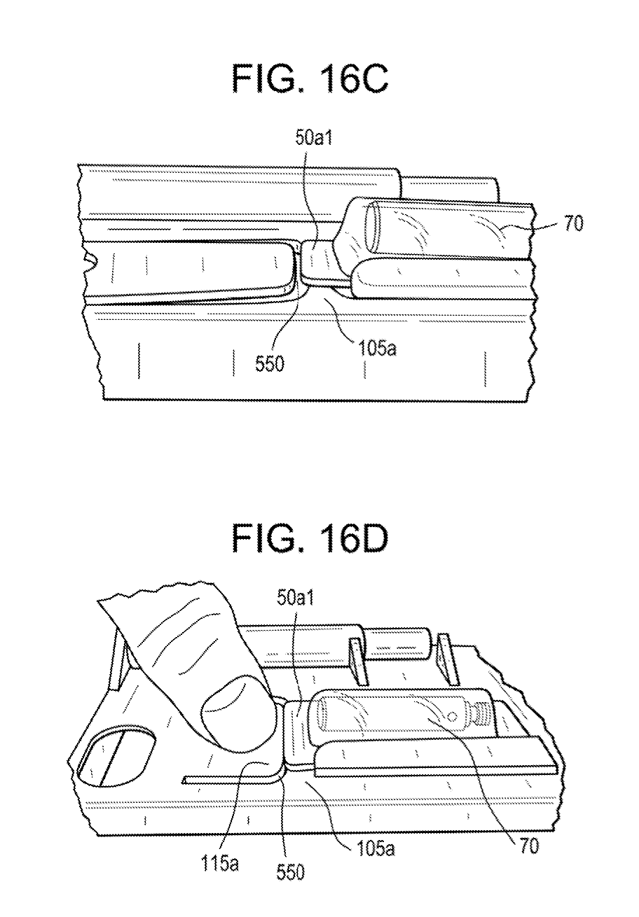

A spare cartridge 70 disposed in a blister pack 50a may be stored in the protective case 100 by sliding edges of the blister pack 50a in the two slots 111a/b formed by ledges 112a/b of the shell 105 until the resilient locking member 115 may be actuated to a locked position. For instance, a raised lower lip 550 of locking member 115 may project, at an angle, away from back-side of shell 115 (depicted more clearly in FIG. 16C) in position of “rest.” An adult vaper may then depress a distal end 115a of locking member 115, such that the lip 550 of locking member 115 becomes somewhat flush with a back-side of shell 105 (depicted in FIG. 16D) in a “non-resting” position, in order to allow a blister pack 50a to slide past the lip 550 of locking member 115, unobstructed. It is noted that the resilient locking member 115 and the two ledges 112a/b may be integrally formed along with the shell 105 of protective case 100 from a single molded piece of polymer material. It should further be understood that the resilient locking member 115 may be flexible, allowing an adult vaper to be able to depress the resilient locking member 115 without excessive force, in order to release the blister pack 50a from a locked position.

Collectively referring to FIGS. 3-6, the shell 105 may include a receiver or cavity 125 that may accept an e-vaping article. The e-vaping article may, for example, be an entire e-vaping device 60 (as shown for instance in FIG. 1). Alternatively, the e-vaping article may instead be only a portion of the overall e-vaping device 60. For instance, the cavity may accept and store an e-vaping article that may be an e-vaping item of an overall e-vaping device 60, such as a reusable section 72 or a cartridge 70. For purposes of discussion, the term “e-vaping item” will be used to describe the e-vaping article that may be stored in the cavity 125.

A stop 126 may be positioned below the cavity 125 in order to act as a physical stop for the e-vaping item. In use, an e-vaping item may be inserted into the cavity 125 of the protective case 100 until a distal end of the e-vaping item reaches and contacts the stop 126, where the stop 126 may impede the e-vaping item from sliding out of the cavity 125. In this manner, an e-vaping item may be stored in the cavity 125 such that the e-vaping item may be protected from becoming damaged or dirty. The dimensions of the cavity 125 may be selected such that an e-vaping item may be held in the cavity 125 by a frictional force (sliding fit) between an exterior surface of an e-vaping article and an interior surface of the cavity 125. More specifically, the cavity 125 may be so dimensioned that an adult vaper may slide the e-vaping item into and out of the cavity 125. However, the e-vaping item may not be capable of sliding out of the cavity 125 under the force of gravity.

As shown in FIG. 6, the protective case 100 may include an auxiliary battery 160 disposed therein. The auxiliary battery 160 may be operable to electrically connect to a battery of a handheld electronic device housed in the shell 105 of the protective case 100 to thereby recharge the battery of the handheld electronic device. The auxiliary battery 160 may also be operable to electronically connect to a battery of an e-vaping item stored in the cavity 125 of the shell 105 in order to recharge the battery of the e-vaping item. The auxiliary battery 160 may also be operable to recharge both the battery of the e-vaping device and the handheld electronic device at the same time, or alternatively the auxiliary battery 160 may be operable to recharge either the battery of the e-vaping device or the battery of the handheld electronic device, separately.

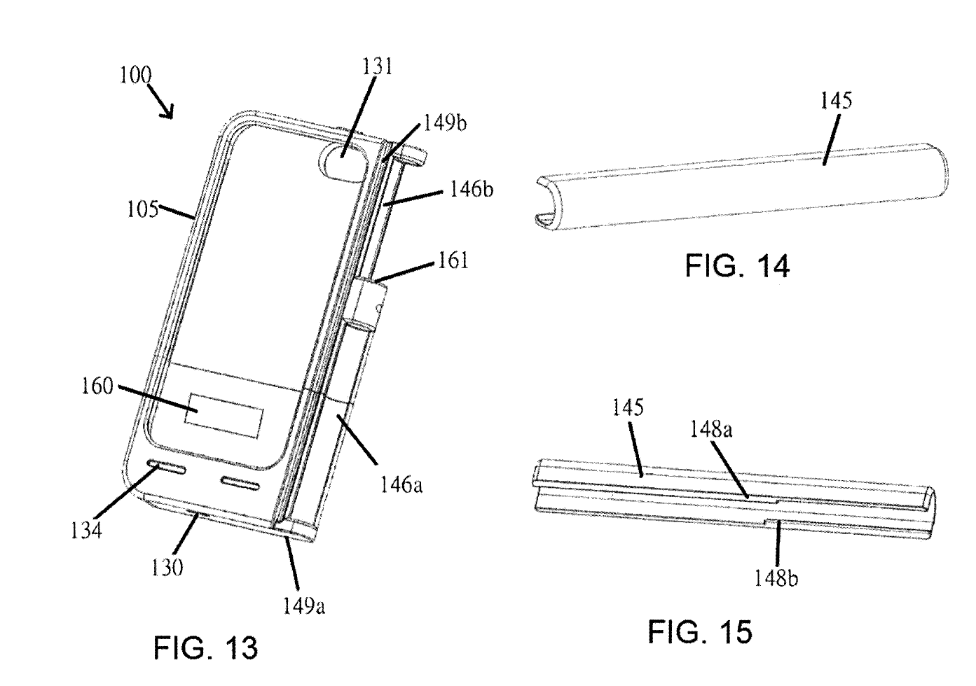

The auxiliary battery 160 may electrically connect to the battery of the handheld electronic device through a connector port of the handheld electronic device. For example, a removable port cover 130a may be capable of sealing device port 130, where the removable port cover 130a may include a conductive contact which may be electronically connected to a device port of a handheld electronic device housed in the shell 105 of the protective case 100. Alternatively, the auxiliary battery 160 of the protective case 100 may be configured to electrically connect to the battery of the handheld electronic device through inductive coupling. The auxiliary battery 160 of the protective case 100 may be configured to electronically connect to a conductive contact of the battery of the e-vaping item (as shown for instance in FIG. 13). Alternatively, the auxiliary battery 160 may be electrically connected to the battery of the e-vaping item through inductive coupling (as shown for instance in FIG. 8).

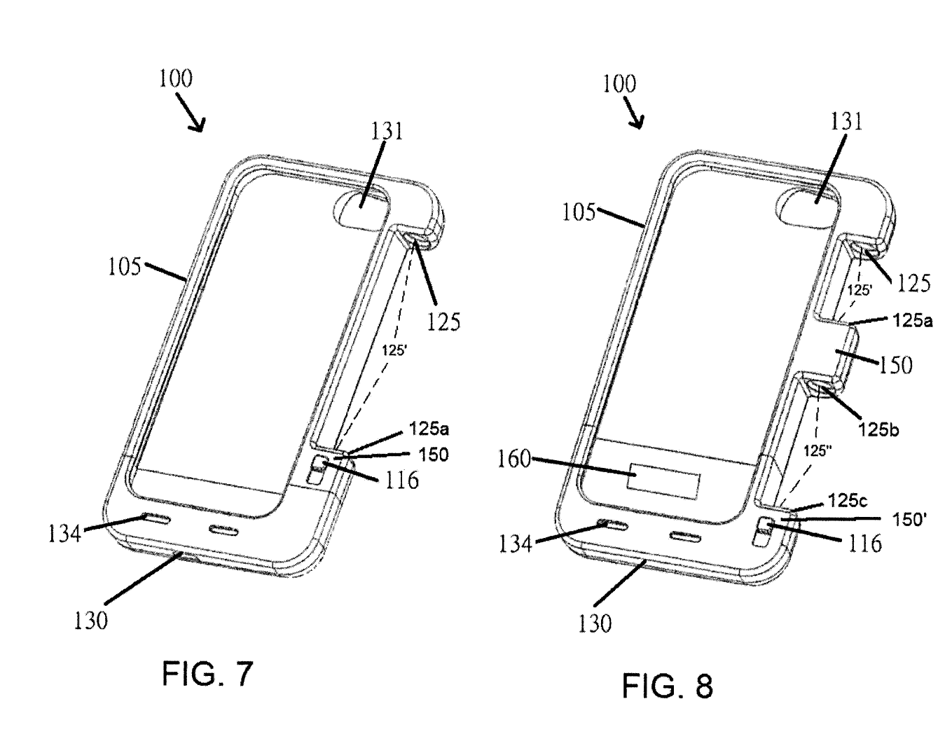

Collectively referring to FIGS. 3-6, the shell 105 of the protective case 100 may include a plurality of ports for accessing items and functionalities of a handheld electronic device that is to be stored in the shell 105. For instance, the shell 105 may include a device port 130 to allow access to a connector port of a handheld electronic device housed in the shell 100. The shell 105 may include a headphone jack port 132 to allow headphones to be plugged into the handheld electronic device. The shell 105 may include a button port 133 to allow an adult vaper to access physical buttons of the handheld electronic device. The shell 105 may include a camera port 131 to allow light to reach a camera of a handheld electronic device housed in the shell 105. The shell 105 may also include speaker ports 134 (see FIG. 7, for instance) which may be arranged such that the protective case 100 does not obstruct sound leaving a speaker of a handheld electronic device housed in the shell 105. It is noted that several of these same ports (described above) are also shown in FIGS. 7-17, and therefore for the sake of brevity, these same ports are not individually described again with regard to each embodiment disclosed in this document.

Collectively referring to FIGS. 3-6, in an alternative embodiment, the opposing ledges 112a/b of the example embodiments may instead be a single ledge 112a capable of slideably receiving one edge of a blister pack 50a, where a longitudinally positioned stop may oppose the single ledge 112a (i.e., the longitudinally positioned stop may be substituted for the other ledge 112b). Furthermore, both ledges 112a/b may instead be replaced by a structure in the form of a “pouch,” where the blister pack 50a is held within the “pouch” by the locking member 115.

As shown in FIG. 7, in an embodiment, the shell 105 may include a retention structure that may be at least one cavity 125, or opposing cavities 125/125a that are collinear with each other. The cavity or cavities 125/125a may retain an end of an e-vaping article that may be an e-vaping item (for example, an entire e-vaping device 60, or a portion of the device such as a single cartridge 70, or a single reusable section 72). A spring 125′ may be included in at least one of the cavities 125/125a. The spring 125′ may be compressed as an end of the e-vaping item is positioned within the cavity or cavities 125/125a, and the spring 125′ may help discharge an end of the e-vaping item, as the e-vaping item is withdrawn from the cavity of cavities 125/125a. A charging station 150, which may be an induction coil or a conductive contact, may be located near one of the cavities 125/125a. If an induction coil is used in the charging station 150, the induction coil may include a primary induction coil that may induce a current in a secondary coil included in an e-vaping item. If a conductive contact is used in the charging station 150, the conductive contact may be configured to electrically contact an anode or cathode connection on an end of the e-vaping item. The charging station 150 may be electrically connected to auxiliary battery 160 in order to cause the auxiliary battery 160 to recharge the e-vaping item (even when the e-vaping item is a fully assembled e-vaping device 60 that is stored in cavities 125/125a in an assembled state). A power switch 116 may be electrically connected to the charging station 150. The power switch 116 may be configured to allow an adult vaper to selectively cause the charging station 150 to be turned on or off, in order to selectively cause the e-vaping item to be charged. The power switch 116 may also, optionally, be configured to selectively allow an adult vaper to cause the auxiliary battery 160 to either charge the e-vaping item via the charging station 150 or charge a power supply of the handheld electronic device.

As shown in FIG. 8, in an embodiment, the shell 105 may include more than one cavity 125/125a/125b/125c. Each pair of cavities 125/125a (and 125b/125c) may be collinear with each other. The cavity or cavities 125/125a/125b/125c may retain an end of an e-vaping article that may be an e-vaping item (for example, an entire e-vaping device 60, or a portion of the device such as a single cartridge 70, or a reusable section 72). At least one spring 125′/125″ may be included in at least one of the cavities 125/125a/125b/125c. The spring 125′/125″ may be compressed as an end of the e-vaping item is positioned within the cavity or cavities 125/125a/125b/125c, and the spring 125′/125″ may help discharge an end of the e-vaping item, as the e-vaping item is withdrawn from the cavity or cavities 125/125a/125b/125c. A charging station 150 may be positioned between pairs of cavities 125/125a and 125b/125c, or alternatively a charging station 150′ may be positioned on one end of a pair of cavities 125b/125c. The charging station 150/150′ may be an induction coil or a conductive contact that may be electrically connected to the auxiliary battery 160 in order to cause the auxiliary battery 160 to recharge the e-vaping item (whether the e-vaping item is a fully assembled e-vaping device 60, or alternatively if the e-vaping item is reusable section 72 of an e-vaping device 60). If an induction coil is used in the charging station 150, the induction coil may include a primary induction coil that may induce a current in a secondary coil included in an e-vaping item. If a conductive contact is used in the charging station 150, the conductive contact may be configured to electrically contact an anode or cathode connection on an end of the e-vaping item. A power switch 116 may be electrically connected to the charging station 150. The power switch 116 may be configured to allow an adult vaper to selectively cause the charging station 150 to be turned on or off, in order to selectively cause the e-vaping item to be charged. The power switch 116 may also, optionally, be configured to selectively allow an adult vaper to cause the auxiliary battery 160 to either charge the e-vaping item via the charging station 150 or charge a power supply of the handheld electronic device.

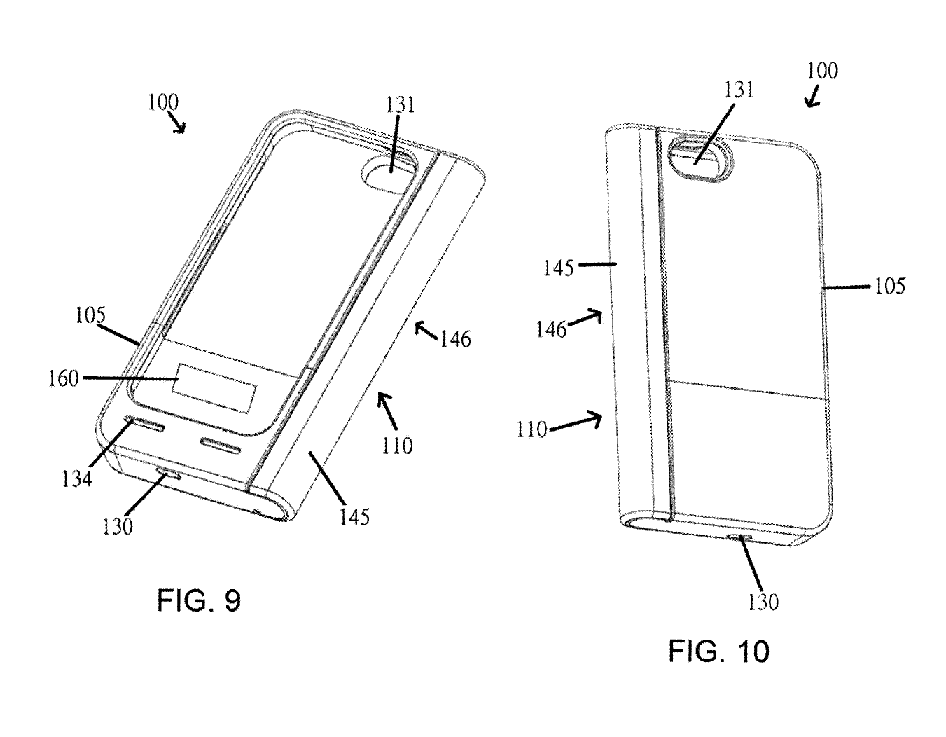

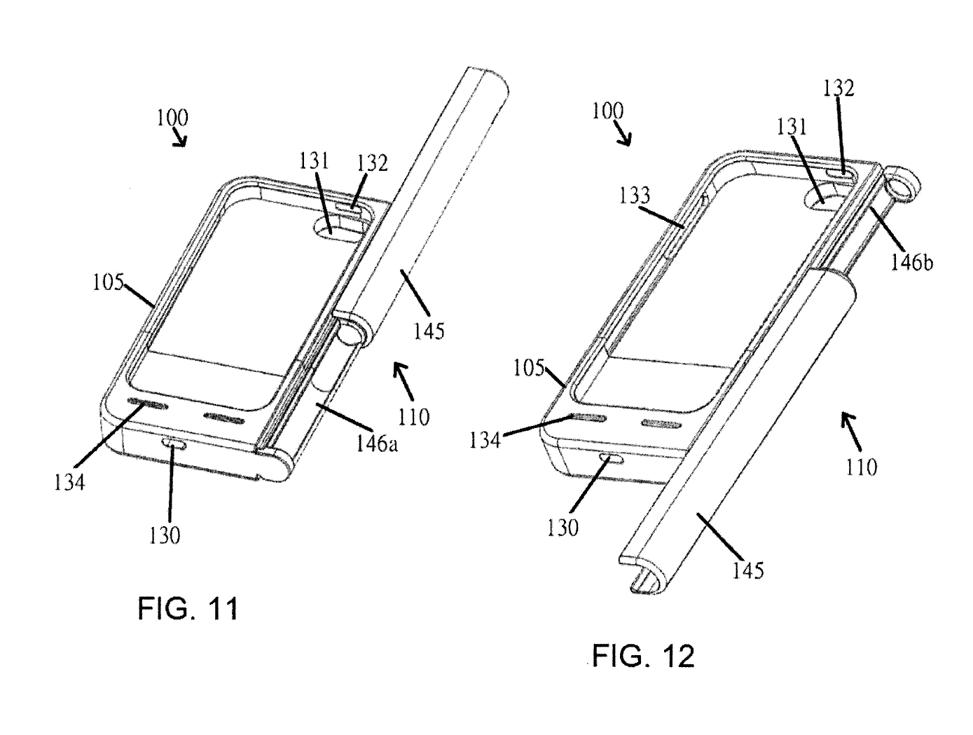

FIGS. 9 and 10 illustrate respective front-side and back-side perspective views of an embodiment of a protective case 100 according to an example embodiment. The protective case 100 may include a shell 105 that may house a handheld electronic device and a retention structure that may be a storage portion 110 (seen more clearly in FIGS. 11 and 12), which may store an e-vaping article such as an e-vaping device 60, or a item the a device 60 such as a cartridge 70 or a reuseable section 72. For purposes of this discussion, the term “e-vaping item” is used to describe an item that may be stored in the storage portion 110.

The storage portion 110 may be located along an edge of the shell 105. The storage portion 110 may include a compartment 146 (seen in more detail in FIGS. 11 and 12) to store the e-vaping item. A slideable cover 145 may seal the compartment 146 when the slideable cover 145 is in a closed position, such that the e-vaping item may be protected from becoming damaged or dirty while stored in the protective case 100.

FIG. 13 is an illustration of the protective case 100 of FIGS. 9 and 10, shown without the slideable cover 145, in accordance with an example embodiment. In particular, FIG. 13 depicts the storage portion 110 as having a first compartment 146a and a second compartment 146b, where the compartments 146a/b may have an arcuate-shaped surface mateable with an e-vaping cartridge 70 to provide storage for the e-vaping cartridge 70. The first compartment 146a may optionally store two cartridges 70. The second compartment 146b may store an e-vaping reuseable section 72. The slideable cover 145 may slide in a first direction (to a first “retracted position”) so that the first compartment 146a may be accessed (see FIG. 11). The slideable cover 145 may also slide in a second direction (to a second “retracted position”) so that the second compartment 146b may be accessed (see FIG. 12). The slideable cover 145 may be positioned in a third position so as to cover both the first and second compartments 146a/b (see FIGS. 9 and 10). Alternatively, the first compartment 146a may store an entire e-vaping device 60 (both a cartridge 70 and a reuseable section 72), and the second compartment 146b may store a spare cartridge 70 such that an adult vaper may conveniently replace a used cartridge 70 when needed.

The second compartment 146b, which may store a reusable section 72 of an e-vaping device 60, may include a conductive contact 161, as shown in FIG. 13. The conductive contact 161 may be electrically connected to an auxiliary battery 160 included in the shell 105, such that the auxiliary battery 160 may recharge the reusable section 72 of an e-vaping device stored in the second compartment 146b.

FIGS. 14 and 15 illustrate the slideable cover 145 in more detail. The slideable cover 145 may include two rails 148a/b which may slide along respective recesses (slots) 149a/b (see FIG. 13) of the shell 105. A first rail 148a, of the two rails, may fit into a first recess 149a of the shell 105, with the first rail 148a being operable to allow the slideable cover 145 to slide in the first direction to the first position so that the first compartment 146a may be accessed. A second rail 148b, of the two rails, may fit into a second recess 149b of the shell 105, where the second rail 148b may be operable to allow the slideable cover 145 to slide in the second direction to a second position such that the second compartment 146b may be accessed. Thus, a spare cartridge 70 may be stored in the protective case 100 by sliding the slideable cover 145 in the first direction to allow access to the first compartment 146a, where the spare cartridge 70 may be inserted in the first compartment 146a. The slideable cover 145 may then slid shut, to a closed position, such that the first compartment 146a may be sealed.

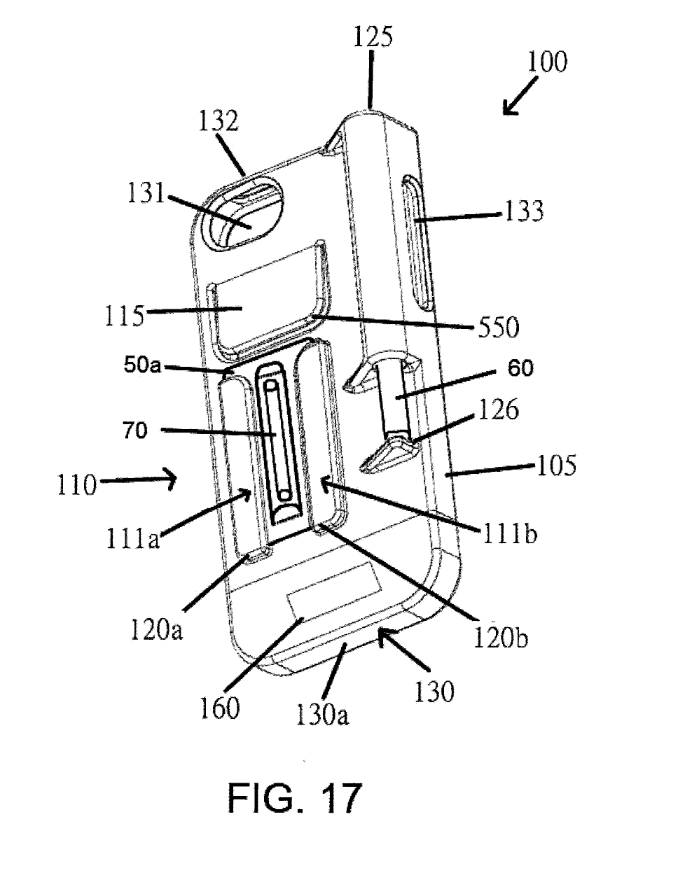

Referring to FIGS. 9-15, portions of surfaces defining the first and second compartments 146a/b, and the slideable cover 145, may include an antimicrobial agent, wherein the portions of the surfaces including the antimicrobial agent may surround a reusable section 72 or a cartridge 70 of an e-vaping device 60. Likewise, referring to FIGS. 3-8 (and FIGS. 16-17, described below), portions of surfaces of cavity 125 may also include an antimicrobial agent. In any of these embodiments, the antimicrobial agent may, in particular, exist in the cavity 125 or compartments 146a/b areas of a case 100, where a mouth end of an e-vaping item may be stored. In this manner, the portion of the surface including the antimicrobial agent may minimize or eliminate bacteria growth thereon, such that any bacteria on the protective case may not be transferred to a mouth end of an e-vaping item. The antimicrobial agent may include at least one of silver, gold, platinum, copper, zinc, and/or oxides thereof.

FIG. 16A-16D illustrate a blister pack 50a being inserted into a storage portion 110 of a protective case 100, in accordance with an example embodiment. FIG. 16A depicts an adult vaper holding a blister pack 50a that is to be inserted into storage portion 110. FIG. 16B depicts the blister pack 50a as being partially inserted into the storage portion, where edges of the blister pack 50a are retained in slots 111a/b formed by ledges 112a/b. FIG. 16C depicts the blister pack 50a fully inserted into storage portion 110. The locking member 115 is in a “locked” position, where the lip 550 of locking member 115 is angled to extend slightly above a rear surface 105a of shell 105. In this “locked” position, a distal end 50a1 of blister pack 50a is obstructed from sliding out of storage portion 110, as the distal end 50a1 contacts the raised lip 550 of the locking member 115. FIG. 16D depicts an adult vaper pressing their finger on a distal end 115a of locking member 115, in order to press locking member 115 into a temporarily “unlocked” position. In the “unlocked” position, lip 550 of locking member 115 is fairly flush with the rear surface 105a of shell 105, allowing a distal end 50a1 of blister pack 50a to slide over lip 550 in order for blister pack 50a to be drawn out of the storage portion 110.

FIG. 17 is an illustration of a blister pack 50a and an e-vaping item (in this case, an e-vaping device 60) being stored in a protective case 100, in accordance with an example embodiment. In particular, the blister pack 50a is shown as being fully inserted into storage portion 110, where an end of the blister pack 50a is pressed against stops 120a/b, and another end of the blister pack 50a is obstructed from sliding out of the storage portion 110 by raised lip 550 of locking member 115 being in the “locked” position (as described in detail in FIGS. 16A-16D). An e-vaping device 60 is shown as being held in cavity 125, with a distal end of the e-vaping device 60 being physically restrained by stop 126. While FIG. 17 shows an e-vaping device 60 being retained in cavity 125, it should be understood that the cavity 125 and stop 126 may be sized and configured to instead retain only a reusable section 72 of an e-vaping device 60, or the cavity 125 and stop 126 may be sized and configured to instead retain only a cartridge 70 of an e-vaping device 60.

It should be understood that the individual features of the embodiments of FIGS. 3-17 are not mutually exclusive, and variations of these features are also contemplated. For instance, cavities 125 and/or compartments 146a/b may retain an overall e-vaping device 60, or alternatively individual portions of an overall e-vaping device (such as a reusable section 72, or a cartridge 70). Further, the cavities 125 and/or compartments 146a/b may retain other e-vaping devices that may be different from the e-vaping device 60 of FIG. 1. For instance, other e-vaping devices that may include an e-vaping tank, an adapter, or other e-vaping items that may be used for e-vaping, may also be stored in the protective case. Likewise, any number of additional cavities or compartments may be added to the example embodiments disclosed in this document. Additionally, a protective case may be configured to store any number of e-vaping devices, or e-vaping items, including multiple e-vaping devices, multiple portions of an e-vaping device, and/or multiple blister packs (which may be retained for storage in the case as individual blister packs 50a, or stored as a joined blister pack pair 50).

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A protective case for a handheld electronic device, comprising:
a shell configured to attach to the handheld electronic device; and
a retention structure attached to the shell, the retention structure being configured to retain at least a first e-vaping article, the first e-vaping article being one of a blister pack and a first e-vaping item, the first e-vaping item being substantially cylindrically-shaped.

2. The protective case of claim 1, wherein the retention structure is a storage portion configured to retain the blister pack, the retention structure including,
a holding member configured to slideably receive and retain at least one edge of a blister pack, and
a locking member configured to impede the blister pack from sliding out of the storage portion.

3. The protective case of claim 2, wherein the holding member includes at least one ledge defining a slot, the slot being configured to receive the at least one edge of the blister pack.

4. The protective case of claim 3, wherein the at least one ledge includes opposing first and second ledges, the first and second ledges having longitudinal lengths that are positioned to be about parallel to each other.

5. The protective case of claim 3, wherein the at least one ledge includes a stop positioned near an end of the at least one ledge, the stop being positioned to physically stop the blister pack from sliding away from the locking member.

6. The protective case of claim 3, wherein the locking member includes a lip on a distal end of the locking member, the lip being configured to impede the blister pack from sliding out of the storage portion.

7. The protective case of claim 6, wherein the lip of the locking member extends away from a surface of the shell while in a resting position, the lip being configured to impede the blister pack from sliding out of the storage portion while in the resting position.

8. The protective case of claim 7, wherein the locking member is configured to be depressed in order to cause the lip to be about flush with the surface of the shell while in a non-resting position, the lip being configured to allow the blister pack to slide out of the storage portion while in the non-resting position.

9. The protective case of claim 6, wherein the at least one ledge and the locking member are configured to retain a blister pack that is one of substantially rectangular and oval shaped, wherein the blister pack has a width of about 2 to 3 cm and a length of about 5 to 6 cm.

10. The protective case of claim 1, wherein the retention structure includes at least a first cavity defined by the shell, the first cavity being configured to slideably receive and retain at least a first portion of the first e-vaping item via a frictional force.

11. The protective case of claim 10, further comprising:
a first stop positioned on an outer surface of the shell and located adjacent to the first cavity, the first stop being configured to physically stop the first e-vaping item from sliding out of the first cavity.

12. The protective case of claim 10, further comprising;
an auxiliary power supply retained in the shell, the auxiliary power supply being configured to electrically charge the first e-vaping item.

13. The protective case of claim 12, further comprising:
a charging station connected to the shell, the charging station being configured to electrically connect to the auxiliary power supply to allow the auxiliary power supply to electrically charge a battery of the first e-vaping item.

14. The protective case of claim 13, wherein the charging station includes a conductive contact that is configured to electrically connect the auxiliary power supply to one of an anode connection and a cathode connection of the first e-vaping item in order to electrically charge the battery of the first e-vaping item.

15. The protective case of claim 13, wherein the charging station includes a primary induction coil that is configured to produce a current in a secondary induction coil of the first e-vaping item in order to electrically charge the battery of the first e-vaping item.

16. The protective case of claim 13, further comprising:
electrical wiring electrically connecting the auxiliary power supply to a power supply of the handheld electronic device in order to allow the auxiliary power supply to electrically charge the power supply of the handheld electronic device.

17. The protective case of claim 16, further comprising:
a power switch with a selectable first position and a second position, the first position of the power switch causing the auxiliary power supply to electrically charge the first e-vaping item via the charging station, the second position of the power switch causing the auxiliary power supply to electrically charge the power supply of the handheld electronic device.

18. The protective case of claim 10, further comprising:
at least one spring is positioned in the first cavity, the at least one spring being configured to assist in discharging the first e-vaping item if the first e-vaping item is being removed from the first cavity.

19. The protective case of claim 10, further comprising:
an antimicrobial agent on an inner surface of at least a portion of the at least one cavity.

20. The protective case of claim 10, further comprising:
the shell defining at least a second cavity configured to slideably receive and retain at least a second portion of the e-vaping item via a friction force,
the first cavity and the second cavity being about collinear with each other.

21. The protective case of claim 1, wherein the retention structure includes at least a first compartment defined by the shell, the first compartment being configured to retain the first e-vaping item.

22. The protective case of claim 20, further comprising:
a cover attached to the shell and configured with selectable first and second positions, the first position being configured to cause the cover to conceal the first compartment, the second position being configured to allow the first compartment to be accessed.

23. The protective case of claim 21, wherein the first compartment includes an arcuate-shaped surface configured to mate with the first e-vaping item.

24. The protective case of claim 21, wherein the cover is a slideable cover including at least one rail that is mateable with at least one recess that is defined by the shell, the at least one recess being positioned adjacent to a longitudinal length of the first compartment.

25. The protective case of claim 24, wherein the slideable cover is configured to slide between the first position and the second position via the at least one rail sliding within the at least one recess.

26. The protective case of claim 25, wherein,
the shell defines at least a second compartment configured to retain at least a second e-vaping item that is substantially cylindrically-shaped,
the slideable cover is further configured to allow the second compartment to be accessed if the slideable cover is in the first position,
the slideable cover is further configured to conceal the second compartment if the slideable cover is in the second position.

27. The protective case of claim 21, wherein,
the first compartment is configured to retain at least a second e-vaping item,
the second e-vaping item being substantially cylindrically shaped.

28. The protective case of claim 26, wherein the slideable cover is further configured to selectably slide to a third position, the slideable cover is further configured to conceal the first and second compartments if the slideable cover is in the third position.

29. The protective case of claim 21, further comprising:
an antimicrobial agent on at least a portion of an inner surface of the first compartment.
